(19) United States
(12) Patent Application Publication
(10) Pub. No.: US 2021/0341234 A1
(43) Pub. Date: Nov. 4, 2021

(54) HEAT DISSIPATION MEMBER

(71) Applicant: NGK Insulators, Ltd., Nagoya-Shi (JP)

(72) Inventors: Megumi FUJISAKI, Kuwana-Shi (JP); Takahiro TOMITA, Chita-Shi (JP); Yusuke OSHITA, Nagoya-Shi (JP)

(73) Assignee: NGK Insulators, Ltd., Nagoya-Shi (JP)

(21) Appl. No.: 17/305,409

(22) Filed: Jul. 7, 2021

Related U.S. Application Data
(63) Continuation of application No. PCT/JP2020/000540, filed on Jan. 9, 2020.

(30) Foreign Application Priority Data
Jan. 10, 2019 (JP) PCT/JP2019/000585
Oct. 2, 2019 (JP) 2019-182462

(51) Int. Cl. F28F 21/04; F28F 3/00

(52) U.S. Cl. CPC F28F 21/04; F28F 2013/001; F28F 3/00

(57) ABSTRACT

A heat dissipation member dissipates heat generated at a heat source. The heat dissipation member may include a substrate having a porosity ratio of 5 volume % or less; and an inorganic porous layer disposed on a surface of the substrate, wherein the inorganic porous layer may have a porosity ratio ranging from 25 volume % or more to 85 volume % or less and have lower thermal conductivity than the substrate. In this heat dissipation member, 15 mass % or more of constituents of the inorganic porous layer may be alumina.

### TECHNICAL FIELD

The disclosure herein discloses a technique relating to a heat dissipation member.

### BACKGROUND ART

Japanese Patent Application Publication No. 2016-28880 (which will be called Patent Document 1) describes a heat dissipation member in which a heat insulating layer is disposed on a surface of a heat dissipation layer (substrate). Specifically, in the heat dissipation member of Patent Document 1, a heat insulating layer which is a silica aerosol-impregnated nonwoven fabric is joined to a surface of a graphite layer (substrate) using an adhesive layer (resin). A heat dissipation member with such a structure can dissipate heat generated at a heat source and reduce transfer of the heat generated at the heat source to a space surrounding the heat dissipation member. That is, the heat dissipation member of Patent Document 1 can dissipate heat generated at a heat source without increasing the temperature in an environment around the heat source.

### SUMMARY OF INVENTION

### Technical Problem

The heat dissipation member of Patent Document 1 is used in an electronic device such as a smartphone or the like. A heat source (electronic component) in the electronic device may reach approximately 100° C. at most. The heat dissipation member of Patent Document 1 sufficiently functions to dissipate the heat of the heat source which can reach approximately 100° C., however, it is difficult to use the heat dissipation member for a heat source that can reach a higher temperature. For example, if the heat dissipation member of Patent Document 1 were used for a heat source that reaches 500° C. or more, the heat dissipation member itself would deteriorate (deterioration of the graphite layer itself, separation of the graphite layer from the heat insulating layer, etc.) and it would fail to sufficiently serve its functions. That is, the heat dissipation member of Patent Document 1 is limited in its use and less versatile. The disclosure herein provides a highly versatile heat dissipation member.

### Solution to Technical Problem

A heat dissipation member disclosed herein is configured to dissipate heat generated at a heat source. This heat dissipation member may comprise a substrate having a porosity ratio of 5 volume % or less and an inorganic porous layer disposed on a surface of the substrate. The inorganic porous layer may have a porosity ratio ranging from 25 volume % or more to 85 volume % or less and have lower thermal conductivity than the substrate. The inorganic porous layer may comprise ceramic fibers, and 15 mass % or more of constituents of the inorganic porous layer may be alumina.

### BRIEF DESCRIPTION OF DRAWINGS

FIG. 1 shows a configuration of a heat dissipation member in a perspective view;

FIG. 2 shows a cross sectional view of the heat dissipation member in an example of use;

FIG. 3 shows a variant of the heat dissipation member in a perspective view;

FIG. 4 shows a variant of the heat dissipation member in a perspective view;

FIG. 5 shows a variant of the heat dissipation member in a perspective view;

FIG. 6 shows a variant of the heat dissipation member in a perspective view;

FIG. 7 shows a variant of the heat dissipation member in a perspective view;

FIG. 8 shows amounts of raw materials used in an experiment; and

FIG. 9 shows results of an experimental example.

### DESCRIPTION OF EMBODIMENTS

A heat dissipation member disclosed herein can be used, for example, to dissipate heat, which is generated at a heat source, to a position distanced from the heat source. The heat dissipation member includes a substrate and an inorganic porous layer that is disposed on a surface of the substrate and has lower thermal conductivity than the substrate. The substrate functions as a radiator plate configured to dissipate the heat generated at the heat source or as a heat transfer member configured to transfer the heat generated at the heat source to a radiator plate distanced from the heat source. The inorganic porous layer functions as a heat insulator configured to thermally insulate the heat source from a space around the heat source. The heat dissipation member disclosed herein includes the inorganic porous layer on the surface of the substrate, and thus it can be suitably used for a heat source that reaches a high temperature of 1000° C. or more.

Thermal conductivity of the substrate may have any value as long as the substrate can execute functions as a heat dissipator. Although it depends on the intended use, the thermal conductivity may range from 10 W/mK or more to 400 W/mK or less. The thermal conductivity of the substrate may be 50 W/mK or more, 100 W/mk or more, 150 W/mk or more, or 200 W/mk or more. The thermal conductivity of the substrate may be 350 W/mk or less, 300 W/mk or less, 250 W/mk or less, 200 W/mk or less, or 150 W/mk or less.

In order to ensure high thermal conductivity, the substrate may have a dense structure. specifically a porosity ratio of 5 volume % or less. A smaller the porosity ratio of the substrate is more preferable. The porosity ratio of the substrate may be 5 volume % or less, 3 volume % or less. 1 volume % or less, or substantially 0 volume % (at a detection limit or less).

The substrate may be constituted of a material having a relatively small coefficient of thermal expansion. This reduces a dimensional change (expansion, shrinkage) of the heat dissipation member (the substrate) accompanying a temperature change at the heat source and improves the durability of the heat dissipation member. That is, the substrate having a small coefficient of thermal expansion reduces deterioration of the substrate and/or the inorganic porous layer accompanying the dimensional change and separation of the substrate from the inorganic porous layer. Specifically, the coefficient of thermal expansion of the substrate may be 11×10⁻⁶/K or less. The coefficient of thermal expansion of the substrate may be appropriately selected depending on the temperature of the heat source for which the heat dissipation member is used and a coefficient of thermal expansion of the inorganic porous layer. For example, the coefficient of thermal expansion of the substrate may be 10×10⁻⁶/K or less, 8×10⁻⁶/K or less, 6×10⁻⁶/K or less, 5.5×10⁻⁶/K or less, 5×10⁻⁶/K or less, 4.5×10⁻⁶/K or less, or 4×10⁻⁶/K or less. The coefficient of thermal expansion of the substrate may, for example, be 1×10⁻⁶/K or more. although it depends on the coefficient of thermal expansion of the inorganic porous layer.

A material of the substrate may be a metal, an alloy, a ceramic, and/or the like, although not limited thereto. Examples of the metal include molybdenum, tungsten. iron, and the like. Examples of the alloy include kovar, invar, carbon steel, chrome steel, nickel steel, stainless steel, and the like. Examples of the ceramic includes AlN, SiC, SiO₂, BN, Si₃N₄, MgO, BeO, Al₂O₃, and the like. When a ceramic is used as the material of the substrate, the material of the substrate is preferably AlN, SiC, or Si₃N₄. The substrate constituted of any one of those materials can satisfy the aforementioned characteristics (the thermal conductivity ranging from 10 W/mK or more to 400 W/mK or less, the porosity ratio of 5 volume % or less). All of the aforementioned materials have a coefficient of thermal expansion of 11×10⁻⁶/K or less. As long as the coefficient of thermal expansion is 11×10⁻⁶/K or less, the substrate may be a composite material using a plurality of the aforementioned materials.

The inorganic porous layer may be disposed only on one surface (front surface) of the substrate or may be disposed on each of both surfaces (front and back surfaces) of the substrate. The inorganic porous layer may coat surfaces of two substrates facing each other with a spacing therebetween. In other words, substrates (a first substrate and a second substrate) may be joined to both surfaces of one inorganic porous layer, respectively. In this case, it is possible to prevent heat generated at a first device disposed on the first substrate side from being applied to a second device disposed on the second substrate side and to release the heat generated at the first device by the first substrate. Similarly, it is possible to prevent heat of the second device from being applied to the first device and to release the heat generated at the second device by the second substrate. That is, by respectively jointing the substrates to both surfaces of one inorganic porous layer, it is possible to execute not only a function as a heat dissipation member for devices (heat sources) hut also a function as a partition plate that thermally insulates the devices from each other.

The heat dissipation member (the substrate) may be in a linear shape (wire shape) or a plate shape (sheet shape), although not limited to having one of those shapes. In case of a linear-shaped substrate, the inorganic porous layer may coat an outer surface of the substrate. In case of a plate-shaped substrate, the inorganic porous layer may coat the entirety of exposed surface of the substrate, may coat end face(s) (front face and/or back face) of the substrate in its thickness direction, may coat end face(s) (side face(s)) of the substrate in its width direction, or may coat end face(s) of the substrate in its longitudinal direction. Further, in case of the plate-shaped substrate, the inorganic porous layer may coat both a front face of a first plate-shaped substrate (a first substrate) and a back face of a second plate-shaped substrate (a second substrate).

The inorganic porous layer may coat the entire surface of the substrate or may coat a part of the surface of the substrate. For example, the inorganic porous layer may coat a part of the substrate except for end(s) (One end or both ends) of the substrate. When the inorganic porous layer coats the front and back faces (faces in the thickness direction) of the plate-shaped substrate, the inorganic porous layer may coat the front and back faces except for parts thereof (e.g., one end or both ends in the longitudinal direction). Alternatively, part(s) coated by the inorganic porous layer may be different between the front face and the back lace; for example, the back face may be entirely coated by the inorganic porous layer and the front face may be coated except for its both ends in the longitudinal direction.

Thermal conductivity of the inorganic porous layer may have any value as long as the inorganic porous layer can execute functions of a heat insulating layer that thermally insulates a heat source (substrate exposed to the heat source) from a space around the heat source. The thermal conductivity of the inorganic porous layer may be lower than that of the substrate, and may, for example, range from 0.05 W/mK or more to 3 W/mK or less. The thermal conductivity of the inorganic porous layer may be 0.1 W/mK or more, 0.2 W/mK or more, 0.3 W/mK or more, 0.5 W/mK or more, 1 W/mK or more, or 2 W/mK or more. Further, the thermal conductivity of the inorganic porous layer may be 2 W/mK or less, 1 W/mK or less, 0.5 W/mK or less, 0.3 W/mK or less, or 0.2 W/mK or less. or 0.1 W/mK or less.

As described, the heat dissipation member dissipates the heat generated at the heat source by the substrate and thermally insulates the heat source (or the substrate) from the space around the heat source by the inorganic porous layer. Thus, it is desirable that a thermal conductivity difference between the substrate and the inorganic porous layer is large. Specifically, the thermal conductivity of the substrate may be 100 times or more the thermal conductivity of the inorganic porous layer. The thermal conductivity of the substrate may be 300 times or more, 500 times or more, 600 times or more, or 1000 times or more the thermal conductivity of the inorganic porous layer.

The inorganic porous layer may be constituted of a single material in its thickness direction (in a range from the face in contact with the surface of the substrate to the face exposed to an external environment). That is, the inorganic porous layer may be a single layer. The inorganic porous layer may be configured of a plurality of layers having different compositions in the thickness direction. That is, the inorganic porous layer may have a multi-layer structure in which multiple layers are stacked. Alternatively, the inorganic porous layer may have a gradation structure in which compositions are gradually varied in the thickness direction. When the inorganic porous layer is a single layer, this facilitates manufacturing of the heat dissipation member (in a process in which the inorganic porous layer is formed on the substrate surface). When the inorganic porous layer has a multi-layer or gradation structure, the inorganic porous layer can be varied in characteristics in the thickness direction. The structure of the inorganic porous layer (single layer, multi-layer structure, gradation structure) can be appropriately selected according to the environment in which the heat dissipation member is used.

The inorganic porous layer may comprise ceramic fibers. That is, the inorganic porous layer may be constituted of a base material (matrix) and ceramic fibers. The ceramic fibers moderate a decrease in the strength (mechanical strength) of the inorganic porous layer. Further, the inorganic porous layer including the ceramic fibers enables the inorganic porous layer itself to reduce the influence of a thermal expansion rate difference between the substrate and the inorganic porous layer. Specifically, the inorganic porous layer can change its shape following a dimensional change (thermal expansion, thermal shrinkage) of the substrate, and thus separation of the inorganic porous layer from the substrate can be prevented.

The inorganic porous layer may comprise 15 mass % or more of alumina constituent. That is, 15 mass % or more of constituents of the inorganic porous layer may be alumina. The inorganic porous layer including 15 mass % or more of alumina constituent allows the inorganic porous layer to have a high melting point, and thus the heat dissipation member (the inorganic porous layer) can maintain its shape even when the heat source is at a high temperature and the durability of the heat dissipation member can be improved. Further, since alumina has a relatively small coefficient of thermal expansion (7.2×10⁻⁶/K), the inorganic porous layer including 15 mass % or more of alumina constituent reduces the dimensional change of the heat dissipation member (the inorganic porous layer) accompanying the temperature change at the heat source and improves the durability of the heat dissipation member. The alumina constituent may account for 15 mass % or more, 20 mass % or more, 30 mass % or more, 40 mass % or more, or 50 mass % or more of the constituents of the inorganic porous layer. The alumina constituent may constitute the matrix or the ceramic fibers (alumina fibers).

The inorganic porous layer may comprise, as its matrix, a material having a coefficient of thermal expansion of less than 5×10⁻⁶/K. Examples of such a material include mullite (Al₆O₁₃Si₂), silicon dioxide (SiO₂), silicon carbide (SiC), aluminum nitride (AlN), low thermal expansion glass, aluminum-titanate (TiO₂.Al₂O₃). zirconium phosphate, spodumene (LiAlSi₂O₆), eucryptite (LiAlSiO₄), and the like. The inorganic porous layer may at least one of those materials as the matrix. The coefficient of thermal expansion of the material included in the matrix of the inorganic porous layer may be less than 3×10⁻⁶/K or less than 2×10⁻⁶/K. Among the aforementioned materials, cordierite is suitable as the matrix of the inorganic porous layer. Cordierite is highly resistance to heat and has a small coefficient of thermal expansion (less than 0.1×10⁻⁶/K). Thus, the matrix including cordierite reduces a dimensional change of the heat dissipation member (the inorganic porous layer) accompanying a temperature change at the heat source and improves the durability of the heat dissipation member.

The material having the coefficient of thermal expansion of less than 5×10⁻⁶/K (e.g., cordierite) may account for 30 mass % or more, 40 mass % or more, 50 mass % or more, 60 mass % or more, 70 mass % or more, or 80 mass % or more of the overall inorganic porous layer (the ceramic fibers+the matrix). Further, the material having the coefficient of thermal expansion of less than 5×10⁻⁶/K may account for 60 mass % or more, 70 mass % or more, 80 mass % or more. 90 mass % or more, or 100 mass % or more of the matrix of the inorganic porous layer. That is, the inorganic porous layer may be the matrix that includes the material having the coefficient of thermal expansion of less than 5×10⁻⁶/K with the ceramic fibers contained therein.

The porosity ratio of the inorganic porous layer may range from 25 volume % or more to 85 volume % or less. With the porosity ratio of 25 volume % or more, the inorganic porous layer can sufficiently function as a heat insulating layer. With the porosity ratio of 85 volume % or less, the strength of the inorganic porous layer can be sufficiently ensured and the durability of the heat dissipation member (the inorganic porous layer) can be improved. The porosity ratio of the inorganic porous layer may be 30 volume % or more, 40 volume % or more, 50 volume % or more, 60 volume % or more, 62 volume % or more, 64 volume % or more, 68 volume % or more, or 70 volume % or more. Further, the porosity ratio of the inorganic porous layer may be 80 volume % or less, 70 volume % or less, 68 volume % or less, 66 volume % or less, 64 volume % or less, 62 volume % or less, or 60 volume % or less. When the inorganic porous layer has the multi-layer structure or the gradation structure, the porosity ratio of the inorganic porous layer may be 25 volume % or more and 85 volume % or less as a whole, and the porosity ratio may be varied in the thickness direction. In this case, the inorganic porous layer may include a part with the porosity ratio of less than 25 volume % or a part with the porosity ratio of more than 85 volume %.

The coefficient of thermal expansion of the inorganic porous layer may be adjusted according to the coefficient of thermal expansion of the substrate, and it may range from 1×10⁻⁶/K or more to 6×10⁻⁶/K or less, although not limited to this range. With the inorganic porous layer having the coefficient of thermal expansion of 1×10⁻⁶/K or more, the influence of thermal expansion rate difference between the substrate and the inorganic porous layer can be reduced. Further, with the inorganic porous layer having the coefficient of thermal expansion of 6×10⁻⁶/K or less, a dimensional change of the inorganic porous layer accompanying a temperature change at the heat source is reduced and the durability of the heat dissipation member is improved. The coefficient of thermal expansion of the inorganic porous layer may be 2×10⁻⁶/K or more, 3×10⁻⁶/K or more, 3.5×10⁻⁶/K or more, 4×10⁻⁶/K or more. 4.5×10⁻⁶/K or more, 5×10⁻⁶/K or more, or 5.5×10⁻⁶/K or more. Further, the coefficient of thermal expansion of the inorganic porous layer may be 5.5×10⁻⁶/K or less, 5×10⁻⁶/K or less, 4.5×10⁻⁶/K or less, or 4×10⁻⁶/K or less.

As described, by reducing the thermal expansion rate difference between the substrate and the inorganic porous layer, separation of the substrate from the inorganic porous layer can be reduced even when the heat dissipation member dimensionally changes (thermal expansion, thermal shrinkage) accompanying a temperature change at the heat source. Thus, the coefficients of thermal expansion of the inorganic porous layer and the substrate may be adjusted to satisfy the following formula 1, where α1 is the coefficient of thermal expansion of the inorganic porous layer and α2 is the coefficient of thermal expansion of the substrate. The value “α1/α2” may be 0.55 or more, 0.6 or more, 0.7 or more, 0.8 or more, 0.9 or more, 1 or more, or 1.1 or more. Further, the value “α1/α2” may be 1.1 or less, 1.0 or less, 0.9 or less, 0.8 or less, 0.7 or less, or 0.65 or less.

0.5<α1/α2<1.2 (1)

The thickness of the inorganic porous layer may be 1 mm or more, although it depends on the intended use (required performance). When the thickness of the inorganic porous layer is 1 mm or more, the inorganic porous layer can fully exercise thermal insulation. It should be noted that if ceramic fibers were not used in the inorganic porous layer, the inorganic porous layer would shrink in the manufacturing process (e.g., in a firing process), and thus it would be difficult to maintain the thickness at 1 mm or more. Since the inorganic porous layer disclosed herein comprises the ceramic fibers, the shrinkage in the manufacturing process is diminished, and thus the thickness can be maintained at 1 mm or more. If the thickness of the inorganic porous layer were too large, improvement in properties might not worth the costs (costs for manufacturing and materials). Therefore, the thickness of the inorganic porous layer may be 30 mm or less, 20 mm or less, 15 mm or less, 10 mm or less, or 5 mm or less, although it is not limited thereto.

The inorganic porous layer may comprise granular particles ranging from 0.1 μm or more to 10 μm or less. In shaping (firing) the inorganic porous layer, the ceramic fibers are combined to each other via the granular particles, and thereby the resultant inorganic porous layer has high strength.

Ceramic particles may be used as a joint material that joins aggregation materials together that constitute a frame of the inorganic porous layer, such as plate-shaped ceramic particles (which will be described later), the ceramic fibers, and the like. The ceramic particles may be granular particles ranging from 0.1 μm or more to 10 μm or less. The diameter of the ceramic particles may be increased due to sintering and/or the like in the manufacturing process (e.g., in the firing process). That is, the ceramic particles may be granular particles ranging from 0.1 μm or more to 10 μm or less (average particle size before firing) as a raw material of the inorganic porous layer. The ceramic particles may be 0.5 μm or more and 5 μm or less. A material having a small coefficient of thermal expansion (less than 5×10⁻⁶/K) may be used as the material of the ceramic particles. Examples of such a material with a small coefficient of thermal expansion include mullite, silicon dioxide, silicon carbide, aluminum nitride, low thermal expansion glass, aluminum-titanate, zirconium phosphate, spodumene, eucryptite, and the like. A metal oxide may be also used as the material of the ceramic particles, for example. Examples of the metal oxide include alumina (Al₂O₃), spinel (MgAl₂O₄), titania (TiO₂), zirconia (ZrO₂), magnesia (MgO), mullite, cordierite (MgO.Al₂O₃.SiO₂), and the like.

In the heat dissipation member disclosed herein, the inorganic porous layer may comprise plate-shaped ceramic particles. Using the plate-shaped ceramic particles allows a part of the ceramic fibers to be replaced with the plate-shaped ceramic particles. Typically, a length (longitudinal dimension) of the plate-shaped ceramic particles is shorter than a length of the ceramic fibers. Therefore, heat transfer pathways in the inorganic porous layer are severed by using the plate-shaped ceramic particles, and thus heat tends to be less transferred in the inorganic porous layer. As a result, thermal insulation of the inorganic porous layer is improved further. It should be noted that the “plate-shaped ceramic particles” mean ceramic particles with an aspect ratio of 5 or more and a longitudinal dimension ranging from 5 μm or more to 100 μm or less.

The plate-shaped ceramic particles can function as an aggregation material or a reinforcement material in the inorganic porous layer. That is, the plate-shaped ceramic, as with the ceramic fibers, improves the strength of the inorganic porous layer and diminishes the shrinkage of the inorganic porous layer in the manufacturing process. The use of plate-shaped ceramic particles severs the heat transfer pathways in the inorganic porous layer. Thus, as compared with a configuration in which only the ceramic fibers are used as the aggregation material, the heat generated at the heat source is less likely to transfer in the inorganic porous layer and it is possible to provide better thermal insulation for the heat source and the environment surrounding the heat dissipation member.

The plate-shaped ceramic particles have a rectangular shape or a needle shape and have a longitudinal dimension ranging from 5 μm or more to 100 μm or less. With the longitudinal dimension of 5 μm or more, it is possible to curtail excessive sintering of the ceramic particles. With the longitudinal dimension of 100 μm or less, it is possible to produce the aforementioned effect of severing the heat transfer pathways in the inorganic porous layer, and thus the plate-shaped ceramic particles can be suitably used in the heat dissipation member intended to be used in a high-temperature environment. The plate-shaped ceramic particles may have an aspect ratio ranging from 5 or more to 100 or less. With the aspect ratio of 5 or more, it is possible to favorably curtail sintering of the ceramic particles, while with the aspect ratio of 100 or less, it is possible to moderate a decrease in the strength of the plate-shaped ceramic particles themselves. In addition to the aforementioned metal oxides used as the material of the ceramic particles, minerals, clay, and glass such as talc (Mg₃Si₄O₁₀(OH)₂), mica, kaolin, and the like can be used as the material of the plate-shaped ceramic particles.

As described, in the heat dissipation member disclosed herein, the inorganic porous layer comprises the ceramic fibers. The ceramic fibers can function as an aggregation material or a reinforcement material in the inorganic porous layer. That is, the ceramic fibers improve the strength of the inorganic porous layer and also diminish the shrinkage of the inorganic porous layer in the manufacturing process. The ceramic fibers may have a length ranging from 50 μm or more to 200 μm or less. Further, the ceramic fibers may have a diameter (average diameter) ranging from 1 μm to 20 μm. A volume ratio of the ceramic fibers in the inorganic porous layer (volume ratio of the ceramic fibers relative to materials constituting the inorganic porous layer) may range from 5 volume % or more to 25 volume % or less. With 5 volume % or more of the ceramic fibers, it is possible to sufficiently diminish the shrinkage of the ceramic particles in the inorganic porous layer in the manufacturing process (firing process) of the inorganic porous layer. Further, with 25 volume % or less of the ceramic fibers, it is possible to sever the heat transfer pathways in the inorganic porous layer, and thus they can be suitably used in the heat dissipation member intended to be used in a high-temperature environment. The same materials as those of the plate-shaped ceramic particles mentioned above can be used as the material of the ceramic fibers.

A content percentage of aggregation and reinforcement materials (which include the ceramic fibers, the plate-shaped ceramic particles, and the like, and will be simply termed aggregation materials) in the inorganic porous layer may range 15 mass % or more to 50 mass % or less. With the content percentage of the aggregation materials in the inorganic porous layer being 15 mass % or more, it is possible to sufficiently diminish the shrinkage of the inorganic porous layer in the firing process. Further, with the content percentage of the aggregation materials in the inorganic porous layer being 50 mass % or less, the aggregation materials are favorably joined together by the ceramic particles. The content percentage of the aggregation materials in the inorganic porous layer may be 20 mass % or more, 30 mass % or more, or 40 mass % or more. Further, the content percentage of the aggregation materials in the inorganic porous layer may be 40 mass % or less or 30 mass % or less.

As described, both the ceramic fibers and the plate-shaped ceramic particles can function as aggregation materials or reinforcement materials in the inorganic porous layer. However, in order to surely diminish the shrinkage of the inorganic porous layer after the heat dissipation member has been manufactured (after the firing), a content percentage of the ceramic fibers in the inorganic porous layer may be at least 5 mass % or more even when both the ceramic fibers and the plate-shaped ceramic particles are used as the aggregation materials. The content percentage of the ceramic fibers may be adjusted within a range of 5 mass % or more and 50 mass % or less.

When both the ceramic fibers and the plate-shaped ceramic particles are used as the aggregation materials, a ratio (ratio by weight) of the plate-shaped ceramic particles relative to the total aggregation materials may be 90% or less. In other words, the ceramic fibers may account for at least 10% or more of the aggregation materials in mass ratio. The ratio (ratio by weight) of the plate-shaped ceramic particles relative to the total aggregation materials may be 60% or less, 50% or less. 40% or less, or 34% or less. The ratio of the plate-shaped ceramic particles relative to the total aggregation materials may be 33% or more, 40% or more, 50% or more, or 60% or more. Specifically, the content percentage of the plate-shaped ceramic particles in the inorganic porous layer may be 10 mass % or more, 20 mass % or more, or 30 mass % or more. Further, the content percentage of the plate-shaped ceramic particles may be 30 mass % or less, 20 mass % or less, or 10 mass % or less.

As described. the inorganic porous layer may be constituted of one or more materials of: ceramic particles (granular particles), plate-shaped ceramic particles, and ceramic fibers. The ceramic particles. the plate-shaped ceramic particles, and the ceramic fibers may each contain, as its constituent, alumina, cordierite, titania, and/or the like. In other words, the ceramic particles, the plate-shaped ceramic particles, and the ceramic fibers may be constituted of alumina, cordierite, titania, and/or the like. The inorganic porous layer may comprise 15 mass % or more of alumina constituent relative to the total of constituent materials (constituent substances). Although the matrix and the ceramic fibers may comprise any constituent, the inorganic porous layer comprises at least the ceramic fibers.

In a heat dissipation member intended to be used in a particularly high-temperature environment, the inorganic porous layer may comprise 25 mass % or less of SiO₂. This reduces formation of an amorphous layer in the inorganic porous layer, and thereby heat resistance (durability) of the inorganic porous layer is improved.

To form the inorganic porous layer, a mixture of raw materials including binders, a pore-forming agent, and a solvent may be used other than the ceramic particles, the plate-shaped ceramic particles, and the ceramic fibers. Inorganic binders may be used as the binders. Examples of the inorganic binders include alumina sol, silica sol, titania sol, zirconia sol, and the like. These inorganic binders can provide increased strength to the inorganic porous layer after firing. As the pore-forming agent, a macromolecular pore-forming agent, carbon-based powder, and/or the like can be used. Examples thereof specifically include acrylic resin, melamine resin, polyethylene particles, polystyrene particles, carbon black powder, graphite powder, and the like. The pore-forming agent may have any shape according to the purpose, and may have, for example, a spherical shape, a plate shape, a fiber shape, or the like. The porosity ratio and pore size of the inorganic porous layer can be adjusted by selecting an added amount, size, and/or shape of the pore-forming agent. The solvent may be any solvent so long as it can adjust the viscosity of the raw materials without affecting the other materials. As the solvent. water, ethanol, isopropyl alcohol (IPA), or the like can be used.

The inorganic binders are also a constituent material of the inorganic porous layer. Thus, if alumina sol, titania sol, and/or the like are used to form the inorganic porous layer, the inorganic porous layer may comprise 15 mass % or more of alumina constituent relative to the total constituent materials including the inorganic binders.

Regarding the heat dissipation member disclosed herein, the inorganic porous layer may be formed on a surface of the substrate by applying the aforementioned raw materials on the surface of the substrate, and drying and firing them. As a method of applying the raw materials, dip coating. spin coating, spray coating, slit die coating, thermal spraying, aerosol deposition (AD) method. printing, application with a brush, application with a pallet, mold-casting forming, or the like can be used. If the inorganic porous layer with large thickness is required or if the inorganic porous layer has the multilayer structure, the required thickness or the multilayer structure may be obtained by repeating the application and drying of the raw materials for multiple times. The aforementioned application methods can be used as an application method to form a coating layer (which will be described later).

The heat dissipation member disclosed herein may comprise a coating layer disposed on a surface of the inorganic porous layer that is opposite to a surface thereof on which the substrate is disposed. That is, the inorganic porous layer may be interposed between the substrate and the coating layer. The coating layer may be disposed over the entire surface of the inorganic porous layer (that is opposite to the surface thereof on which the substrate is disposed) or on a part of the surface of the inorganic porous layer. The coating layer can protect (reinforce) the inorganic porous layer.

The material of the coating layer may be a porous ceramic or dense ceramic. Examples of the porous ceramic used in the coating layer include zirconia (ZrO₂), partially stabilized zirconia, stabilized zirconia, and the like. The examples further include yttria-stabilized zirconia (ZrO₂—Y₂O₃:YSZ), metal oxides obtained by adding Gd₂O₃, Yb₂O₃, Er₂O₃, and the like to YSZ, ZrO₂—HfO₂—Y₂O₃; ZrO₂—Y₂O₃—La₂O₃, ZrO₂—HfO₂—Y₂O₃—La₂O₃, HfO₂—Y₂O₃, CeO₂—Y₂O₃, Gd₂Zr₂O₇, Sm₂Zr₂O₇, LaMnAl₁₁O₁₉, YTa₃O₉, Y_{0.7}La_{0.3}Ta₃O₉, Y_{1.08}Ta_{2.76}Zr_{0.24}O₉, Y₂Ti₂O₇, LaTa₃O₉, Yb₂Si₂O₇, Y₂Si₂O₇, Ti₃O₅, and the like. Examples of the dense ceramic used in the coating layer include alumina, silica, zirconia, and the like. Removing the ceramic fibers from the aforementioned constituent materials of the inorganic porous layer provides a low porosity ratio (density property), and this is used for the coating layer. Alternatively, the coating layer may be constituted of the same materials as those of the inorganic porous layer without using the pore-forming agent. By using the porous or dense ceramic as the coating layer, the inorganic porous layer can be reinforced and separation of the inorganic porous layer from the surface of the substrate can be reduced. Using the dense ceramic as the coating layer inhibits, for example, a high-temperature gas from passing through the inorganic porous layer and/or from staying within the inorganic porous layer. As a result, it is expected to produce an effect of reducing heat transfer from the high-temperature gas to the substrate. Further, using the dense ceramic as the coating layer improves an effect of electrically insulating the substrate from the external environment.

The material of the coating layer may be a porous glass or dense glass. By using the porous or dense glass as the coating layer as well, the inorganic porous layer can be reinforced and separation of the inorganic porous layer from the surface of the substrate can be reduced. The material of the coating layer may be a metal. By disposing a metal layer on the surface of the inorganic porous layer, it is possible to reflect radiation heat from the external environment, and thus the application of heat to the substrate can be reduced further.

(Configuration of Heat Dissipation Member)

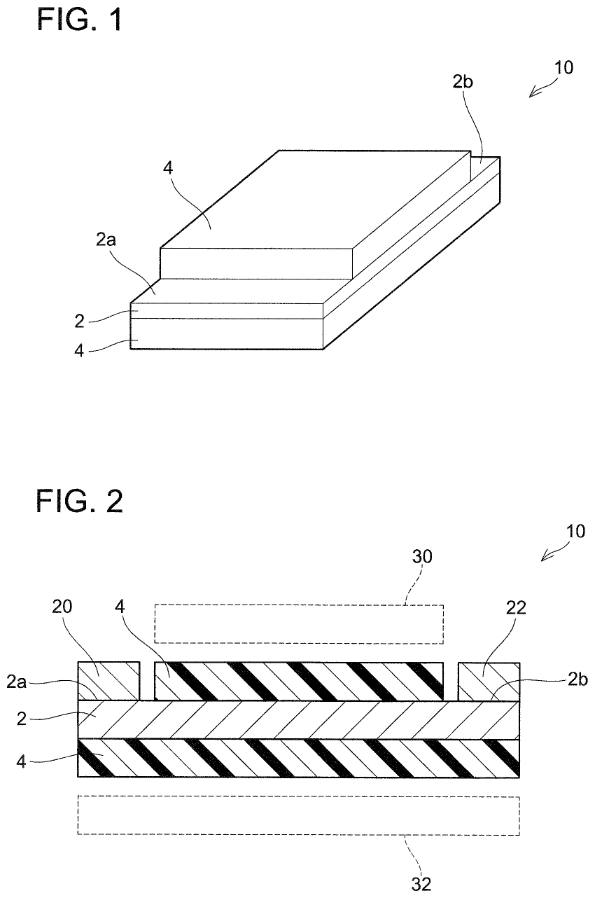

Referring to FIGS. 1 and 2, a configuration of a heat dissipation member 10 will be described. As shown in FIG. 1, the heat dissipation member 10 comprises an aluminum nitride substrate 2 and porous protection layers 4 disposed respectively on both surfaces (end faces in a thickness direction) of the substrate 2. The porous protection layers 4 are an example of the inorganic porous layer. One of the porous protection layers 4 is joined over the entirety of one of the surfaces (back face) of the substrate 2, while on the other surface (front face), the other porous protection layer 4 is joined at an intermediate portion of the substrate 2 that excludes longitudinal ends 2a and 2b of the substrate 2. The porous protection layers 4 are also disposed on side faces (four faces) of the substrate 2, although this is not shown. The heat dissipation member 10 is a thermally conductive member that transfers heat at one end 2a (heat generating side) to the other end 2b (heat dissipation side).

The heat dissipation member 10 was manufactured by submerging the substrate 2, with a part of the front face of the substrate 2 (corresponding to the ends 2a and 2h) masked, into a slurry of raw materials and drying and firing it. The slurry of raw materials was produced by mixing 20 mass % of alumina fibers (average fiber length 140 μm) and 30 mass % of plate-shaped alumina particles (longitudinal dimension 10 μm), which are prime raw materials for alumina constituent and amounts to 50 mass %, 50 mass % of cordierite particles (average particle size 1.5 μm), 10 mass % of alumina sol (1.1 mass % in amount of alumina), 40 mass % of acrylic resin (average particle size 8 μm), and ethanol. It should be noted that the alumina sol, acrylic resin, and ethanol were added in outer percentage to the alumina fibers and the cordierite particles. The slurry of raw materials was adjusted such that it had a viscosity of 2000 mPa·s.

After the raw materials were applied onto the front and back faces of the substrate 2 by submerging the substrate 2 in the slurry of raw materials, the substrate 2 was dried in a dryer for an hour at 200° C. (in atmospheric environment). Thereby, porous protection layers of 300 μm were formed on the front and hack faces of the substrate 2. After this, the process of submerging the substrate 2 in the slurry of raw materials and drying it was repeated three times, and thereby porous protection layers of 1.2 mm were formed on the front and back faces of the substrate 2. Then, the substrate 2 was fired in an electric furnace for three hours at 800° C. (in atmospheric environment), and thereby the heat dissipation member 10 was manufactured. The resultant heat dissipation member 10 included the porous protection layers 4 with a porosity ratio of 67 volume % and had a coefficient of thermal expansion of 4.5×10⁻⁶K⁻¹. It was confirmed that in the heat dissipation member 10, the cordierite particles were interposed between the surfaces (front and back faces) of the substrate 2 and aggregated materials (the alumina fibers and the plate-shaped alumina particles), and joined the surfaces of the substrate 2 to the aggregated materials, although this is not shown. It was further confirmed from an X-ray diffraction result that cordierite was contained in the porous protections layers 4.

FIG. 2 shows the heat dissipation member 10 with a heat generator 20 and a heat dissipator (radiator plate) 22 joined thereto. The heat generator 20 is joined to one end 2a of the heat dissipation member 10, and the heat dissipator 22 is joined to the other end 2b. Heat received by the heat generator 20 travels through the substrate 2 and is then released at the heat dissipator 22. Since the porous protection layers 4 are joined to the front surface (the intermediate portion) and the back surface in the thermally conductive member 10, heat radiation from the substrate 2 is reduced between the heat generator 20 and the heat dissipator 22. Thus, it is possible to reduce the application of heat to devices positioned in a space 30 near the front surface of the thermally conductive member 10 and in a space 32 near the back surface of the thermally conductive member 10.

(Variants of Heat Dissipation Member)

Variants of the heat dissipation member (heat dissipation members 10a to 10c) will be described hereinbelow. The heat dissipation members 10a to 10e are different from the heat dissipation member 10 in the shape of substrate, the position or range where the porous protection layer(s) is formed, and/or whether a coating layer is present or absent. The heat dissipation members 10a to 10e were manufactured through substantially the same processes as those of the heat dissipation member 10, although position(s) to be masked, forming conditions for the porous protection layer(s), and firing conditions after formation of the porous protection layer(s), and the like were adjusted according to the intended use. In the following description, the same features as those of the heat dissipation member 10 may not be described.

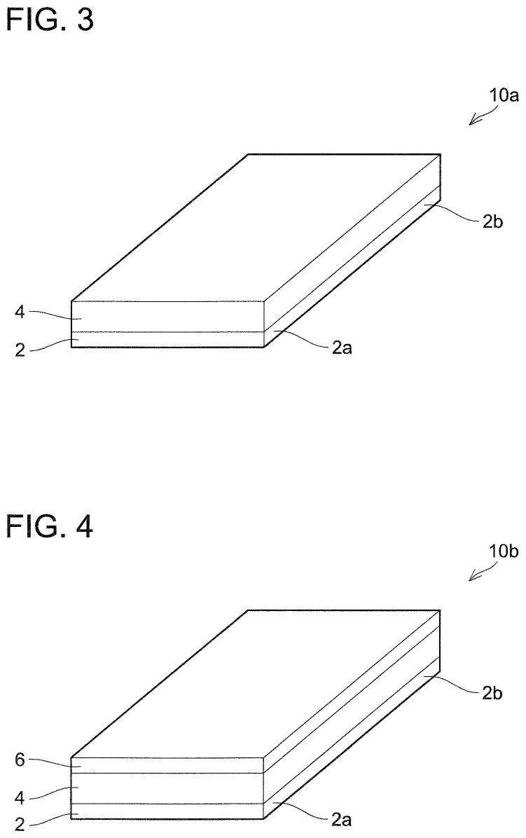

In the heat dissipation member 10a shown in FIG. 3, the porous protection layer 4 is joined to a front surface of the substrate 2 (one of end faces thereof in its thickness direction). In the heat dissipation member 10a, an end 2a, which is one of ends of a back surface of the substrate 2, is joined to a heat generator and the other end 2h is joined to a heat dissipator (radiator plate). In the heat dissipation member 10a, the porous protection layer 4 reduces heat dissipation from the heat generator to the front surface side of the heat dissipation member 10a (the side where the porous protection layer 4 is disposed) and allows heat transfer from the one end 2a to the other end 2b. In the heat dissipation member 10a, the porous protection layer 4 may be disposed at an intermediate portion which is a part of the substrate 2 excluding the longitudinal ends (both ends) 2a and 2b, as in the heat dissipation member 10 (see FIG. 1). In this case, the heat generator and/or the heat dissipator may be joined to the front surface of the substrate 2.

The heat dissipation member 10b shown in FIG. 4 is a variant of the heat dissipation member 10a. In the heat dissipation member 10b, a coating layer 6 is disposed on a surface of the porous protection layer 4 (which is opposite to the surface of the porous protection layer 4 on which the substrate 2 is disposed). The coating layer 6 was formed, after the porous protection layer 4 was formed on the front surface of the substrate 2, by applying a slurry of raw materials to the surface of the porous protection layer 4 using spray and drying and firing it. The slurry of raw materials used to form the coating layer 6 was produced by mixing 20 mass % of alumina fibers (average fiber length 140 μm) and 30 mass % of plate-shaped alumina particles (longitudinal dimension 10 μm), which amount to 50 mass %, 50 mass % of cordierite particles (average particle size 1.5 μm), 10 mass % of alumina sol (1.1 mass % in amount of alumina), and ethanol. That is, the slurry of raw materials used to form the coating layer 6 is the same as the slurry of raw materials used to form the porous protection layer 4 except that the former does not contain the pore forming agent (acrylic resin). The coating layer 6 has a dense structure compared with the porous protection layer 4, and thus it functions as a reinforcement for the porous protection layer 4. The materials of the coating layer 6 can be appropriately changed to, for example, the aforementioned materials according to the intended use. In the heat dissipation member 10b as well, the porous protection layer 4 may be disposed at the intermediate portion, which is the portion of the substrate 2 excluding the longitudinal ends (both ends) 2a and 2b. In this case, the heat generator and/or the heat dissipator may be joined to the front surface of the substrate 2.

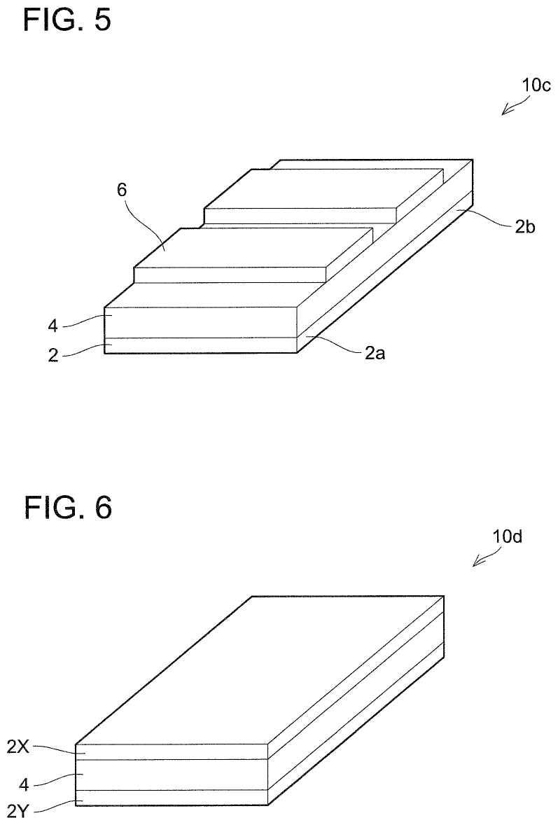

The heat dissipation member 10c shown in FIG. 5 is a variant of the heat dissipation member 10b. In the heat dissipation member 10c, the coating layer 6 is disposed intermittently (partially) on the surface of the porous protection layer 4 in a longitudinal direction of the heat dissipation member 10c. For example, when a difference in coefficient of thermal expansion is large between the coating layer 6 and the porous protection layer 4, it is possible to reduce separation of the coating layer 6 from the porous protection layer 4 by intermittently disposing the coating layer 6 on the surface of the porous protection layer 4. In the heat dissipation member 10c as well, the porous protection layer 4 may be disposed at the intermediate portion, which is the portion of the substrate 2 excluding the longitudinal ends (both ends) 2a and 2b. In this case, the heat generator and/or the heat dissipator may be joined to the front surface of the substrate 2. The feature of the heat dissipation members 10b and 10c (the coating layer being disposed on the surface of the porous protection layer) can be applied to the heat dissipation members 10 and 10a.

In the heat dissipation member 10d shown in FIG. 6, substrates (a first substrate 2X and a second substrate 2Y) are joined to both surfaces (front and back surfaces) of the porous protection layer 4, respectively. In other words, one porous protection layer 4 is connected to the two substrates (first substrate 2X and second substrate 2Y) facing each other with an interval therebetween. A first device (not shown) which is a heat source disposed on the first substrate 2X side is joined to the first substrate 2X, and a second device (not shown) which is a heat source disposed on the second substrate 2Y side is joined to the second substrate 2Y. The first substrate 2X and the second substrate 2Y can dissipate heat generated at the devices. Further, the porous protection layer 4 can reduce the application of heat from one of the devices (e.g., the first device) to the other device (the second device). That is, the heat dissipation member 10 functions as a radiator plate for the two devices and as a partition plate that thermally insulates the two devices from each other.

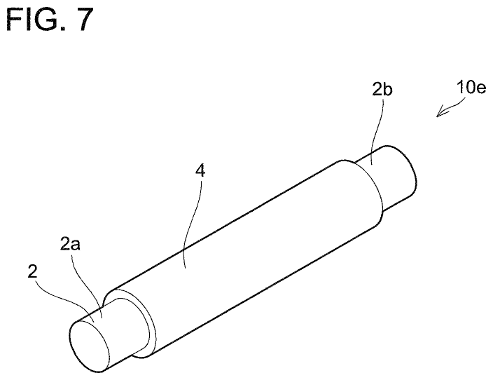

In the heat dissipation member 10e shown in FIG. 7, the substrate 2 is formed of a linear-shaped (line-shaped) metal. In the heat dissipation member 10e, the longitudinal ends (both ends) 2a and 2b of the linear-shaped substrate 2 are exposed. That is, in the heat dissipation member 10e, the porous protection layer 4 is joined to the intermediate portion of the substrate 2, which is the portion of the substrate 2 excluding the ends 2a and 2b. As in the heat dissipation members 10 to 10d, one end 2a is joined to the heat generator and the other end 2b is joined to the heat dissipator in the heat dissipation member 10e, and thus the heat of the heat generator (heat source) can be dissipated at the heat dissipator. Further, in the heat dissipation member 10e, the porous protection layer 4 is disposed at the intermediate portion longitudinally, and thus the application of heat to components around the intermediation portion can be reduced.

### Experimental Example

As described, the porous protection layer was manufactured by producing the slurry of raw materials in which the primary alumina constituents (the alumina fibers and plate-shaped alumina particles), cordierite particles, alumina sol, acrylic resin, and ethanol are mixed, submerging the substrate (aluminum nitride, metal) in the slurry of raw materials, and then drying and firing it. In the present experimental example, in order to see how amounts of the alumina constituents affect characteristics of the porous protection layer, the ratios of the alumina constituents and the cordierite particles were varied and resultant porous protection layers were observed after firing.

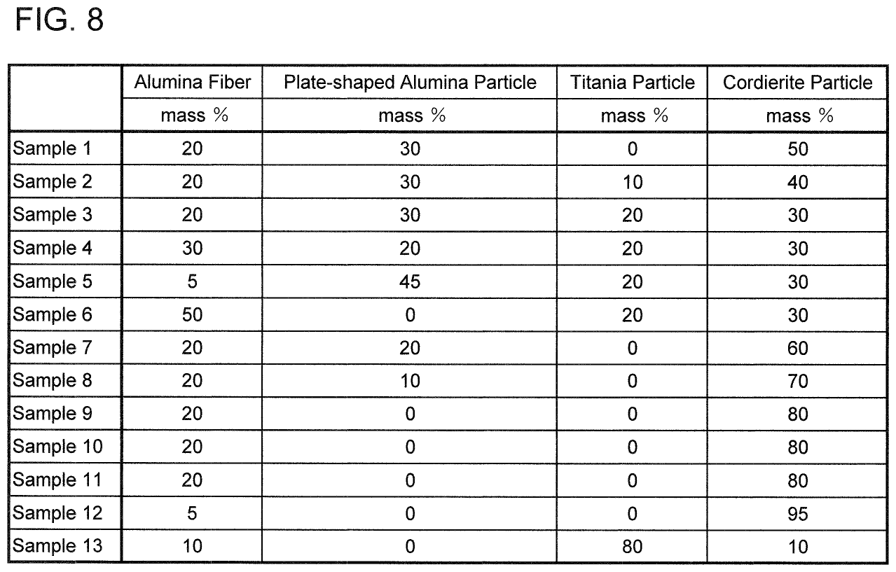

Specifically, slurries of raw materials with varied ratios of the alumina fibers, plate-shaped alumina particles, titania particles, and cordierite particles as shown in FIG. 8 were produced by mixing the alumina fibers, plate-shaped alumina particles, titania particles, and cordierite particles such that the total amounts to 100 mass %, further adding the alumina sol of 10 mass % (1.1 mass % in amount of alumina) and acrylic resin of 40 mass % thereto in outer percentage, and adjusting the viscosities of the slurries by ethanol. The plate-shaped alumina particles were not used in samples 6 and 9 to 13, and the titania particles were not used in samples 1 and 7 to 12. After that, the slurries of raw materials were applied onto aluminum nitride plates (substrates), and then the aluminum nitride plates were dried for an hour at 200° C. in the atmospheric environment and then fired for three hours at 800° C. in the atmospheric environment. For each of the samples, the number of times the slurry of raw materials is applied (how many times the aluminum nitride plate was submerged) was adjusted such that the porous protection layer of approximately 1.2 mm was formed on the aluminum nitride plate. For the sample 10, a silicon carbide plate was used as the substrate instead of the aluminum nitride plate. Further, for the sample 11, a silicon nitride plate was used as the substrate instead of the aluminum nitride plate.

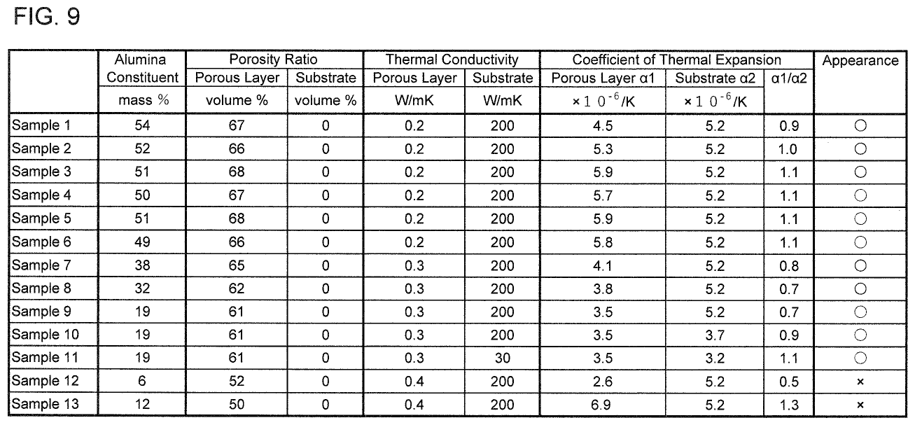

The appearances of the samples after firing were evaluated. The appearance evaluation was conducted by visually checking whether cracks and/or separation were observed or not. In FIG. 9, a sample in which cracks and separation were not observed is shown with “∘” and a sample in which cracks and/or separation were observed is shown with “x”.

Further, for each of the created samples 1 to 13, a ratio (mass %) of the alumina constituents in the porous protection layer was measured. In addition, for the porous protection layers and substrates, the porosity ratios (volume %), thermal conductivity, coefficients of thermal expansion were also measured. The porous protection layers and the substrates were separately measured in the measurement of porosity ratios, thermal conductivity, and coefficients of thermal expansion. For the alumina constituents, amounts of aluminum were measured using an ICP emission analyzer (manufactured by Hitachi High-Tech Corporation, PS3520UV-DD), and those amounts were translated into oxides (Al₂O₃).

Each porosity ratio was calculated by the following formula (2), using a total pore volume (cm³/g) measured by a mercury porosimeter according to JIS 81655 (test methods for pore size distribution of fine ceramic green body by mercury porosimetry) and an apparent density (g/cm³) measured by a gas replacement-type densimeter (manufactured by Micromeritics Instrument Corp., AccuPyc 1330):

Porosity ratio (%)=total pore volume/{(1/apparent density)+total pore volume}×100 (2)

Each thermal conductivity was calculated by multiplying thermal diffusivity, specific heat capacity, and bulk density. The thermal diffusivity was measured using a laser-flash-method thermal constant measuring device and the specific heat capacity was measured using a DSC (differential scanning calorimeter) under the room temperature according to JIS 81611 (measurement methods of thermal diffusivity, specific heat capacity, and thermal conductivity for fine ceramics by flash method). The bulky density (cm³/g) was calculated by the following formula (3). For the thermal diffusivity and specific heat capacity, thermal diffusivity measurement samples and specific heat capacity measurement samples were prepared by shaping the aforementioned slurries of raw materials into bulk bodies of φ10 mm×1 mm thickness and bulk bodies of φ5 mm×1 mm thickness, respectively, and then firing those bulk bodies at 800° C., and the measurement samples were measured.

Bulk density=apparent densityx(1−porosity ratio (%)/100) (3)

For the thermal conductivity, measurement samples were prepared by shaping the aforementioned slurries of raw materials into bulk bodies of 3 mm×4 mm×20 mm and then firing those bulk bodies at 800° C. Then, the measurement samples were measured using a thermal dilatometer according to JIS R1618 (measuring method of thermal expansion of fine ceramics by thermomechanical analysis). FIG. 9 shows the measurement results.

As shown in FIG. 9, in the samples containing 15 mass % or more of alumina constituents (samples 1 to 11), cracks and separation were not observed in the porous protection layers after firing. On the other hand, in the samples 12 and 13 containing less than 15 mass % of alumina constituents (6 mass %. 12 mass %), cracks and/or separation were observed in the porous protection layers after firing. This result infers that the cracks occurred in the porous protection layers in the samples 12 and 13 because the bonding force between ceramics (particles, fibers) was decreased due to the ratio of alumina constituents being less than 15 mass %. Further, in the sample 12, a ratio of the coefficient of thermal expansion of the porous protection layer to that of the substrate is small (α1/α2=0.5) compared with the samples 1 to 11, while in the sample 13, the ratio of the coefficient of thermal expansion of the porous protection layer to that of the substrate is large (α1/α2=1.3) compared with the samples 1 to 11. This result infers that the porous protection layer is likely to separate from the substrate due to the thermal expansion difference between the substrate and the inorganic porous layer when the ratio of the coefficient of thermal expansion of the porous protection layer to that of the substrate (α1/α2) is out of a predetermined range (0.5<α1/α2<1.2). As above, it has been confirmed that deterioration, such as cracks and separation, is less likely to occur in the porous protection layer after firing when the alumina constituents account for 15 mass % or more of the constituents of the porous protection layer. It has been also confirmed from the results of the samples 5 and 12 that cracks and separation can be prevented even when the ratio of ceramic fibers (alumina fibers) in the porous protection layer is small (5 mass %), as long as the porosity ratios of the substrate and the porous protection layer are adjusted to suitable values, the porous protection layer comprises ceramic fibers (alumina fibers), and the porous protection layer comprises 15 mass % or more of alumina constituents.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

1. A heat dissipation member configured to dissipate heat generated at a heat source, the heat dissipation member comprising:
a substrate having a porosity ratio of 5 volume % or less; and
an inorganic porous layer disposed on a surface of the substrate, wherein the inorganic porous layer has a porosity ratio ranging from 25 volume % or more to 85 volume % or less and has lower thermal conductivity than the substrate,
wherein
the inorganic porous layer comprises ceramic fibers, and
15 mass % or more of constituents of the inorganic porous layer is alumina.

2. The heat dissipation member according to claim 1, wherein a matrix of the inorganic porous layer comprises a material having a coefficient of thermal expansion of less than 5×10⁻⁶/K.

3. The heat dissipation member according to claim 2, wherein thermal conductivity of the substrate ranges from 10 W/mK or more to 400 W/mK or less.

4. The heat dissipation member according to claim 3, wherein a coefficient of thermal expansion of the substrate is 11×10⁻⁶/K or less.

5. The heat dissipation member according to claim 4, wherein a coefficient of thermal expansion of the inorganic porous layer ranges from 1×10⁻⁶/K or more to 6×10⁻⁶/K or less.

6. The heat dissipation member according to claim 5, wherein the inorganic porous layer comprises plate-shaped ceramic particles.

7. The heat dissipation member according to claim 6, wherein the inorganic porous layer comprises granular particles ranging from 0.1 μm or more to 10 μm or less.

8. The heat dissipation member according to claim 7, further comprising a coating layer disposed on a surface of the inorganic porous layer that is opposite to a surface thereof on which the substrate is disposed.

9. The heat dissipation member according to claim 1, wherein thermal conductivity of the substrate ranges from 10 W/mK or more to 400 W/mK or less.

10. The heat dissipation member according to claim 1, wherein a coefficient of thermal expansion of the substrate is 11×10⁻⁶/K or less.

11. The heat dissipation member according to claim 1, wherein a coefficient of thermal expansion of the inorganic porous layer ranges from 1×10⁻⁶/K or more to 6×10⁻⁶/K or less.

12. The heat dissipation member according to claim 1, wherein the heat dissipation member satisfies a following formula (1), where α1 is a coefficient of thermal expansion of the inorganic porous layer and α2 is a coefficient of thermal expansion of the substrate.
0.5<α1/α2<1.2 Formula (1)

13. The heat dissipation member according to claim 1, wherein the inorganic porous layer comprises plate-shaped ceramic particles.

14. The heat dissipation member according to claim 1, wherein the inorganic porous layer comprises granular particles ranging from 0.1 μm or more to 10 μm or less.

15. The heat dissipation member according to claim 1, further comprising a coating layer disposed on a surface of the inorganic porous layer that is opposite to a surface thereof on which the substrate is disposed.

16. The heat dissipation member according to claim 4, wherein the heat dissipation member satisfies a following formula (1), where α1 is a coefficient of thermal expansion of the inorganic porous layer and α2 is a coefficient of thermal expansion of the substrate.
0.5<α1/α2<1.2 Formula (1)

17. The heat dissipation member according to claim 16, wherein the inorganic porous layer comprises plate-shaped ceramic particles.

18. The heat dissipation member according to claim 17, wherein the inorganic porous layer comprises granular particles ranging from 0.1 μm or more to 10 μm or less.

19. The heat dissipation member according to claim 18, further comprising a coating layer disposed on a surface of the inorganic porous layer that is opposite to a surface thereof on which the substrate is disposed.
